(19) United States
(12) Patent Application Publication
(10) Pub. No.: US 2008/0220755 A1
(43) Pub. Date: Sep. 11, 2008

(54) Time of day warning for calls to roaming mobile phones

(75) Inventors: William Jackson Bushnell, St. Charles, IL (US); George Y. Ji, Buffalo Grove, IL (US)

Correspondence Address: PATTON BOGGS LLP, 1801 CALFORNIA STREET, SUITE 4900, DENVER, CO, 80202, US

(73) Assignee: Lucent Technologies, Inc., Murray Hill, NJ (US)

(21) Appl. No.: 11/715,626

(22) Filed: Mar. 8, 2007

(51) Int. Cl. H04M 3/42

(52) U.S. Cl. 455/417

(57) ABSTRACT

The present time of day warning system provides the subscriber with the ability to designate at least one time interval during the course of the day when the subscriber prefers not to receive calls on their mobile phone unless these incoming calls are of an urgent nature. In this system, if the subscriber has enrolled in the Time Of Day Warning Service and their mobile phone is turned on, when someone attempts to call the subscriber, the mobile phone system determines the present time of day at the subscriber's present location. If the incoming call is attempted during one of the subscriber-designated blackout time intervals, the incoming call is intercepted. The calling party receives a recorded message which indicates the present time at the subscriber's present location and an indication that the subscriber is not taking calls at this time.

### FIELD OF THE INVENTION

This invention relates to mobile phone networks and to a time of day warning system which provides the roaming mobile subscriber with the ability to designate times of day when the subscriber elects not to receive calls on their mobile phone.

### BACKGROUND OF THE INVENTION

Today, mobile telephone companies around the world have interconnected their mobile phone networks to provide ubiquitous service to subscribers. This includes the ability for the subscriber to roam between carriers where incoming calls are delivered to a subscriber's mobile phone even when the subscriber has roamed to another carrier's network.

For example, a subscriber who is served by a mobile carrier in the United States can take their mobile phone to China and have their incoming calls forwarded from the US carrier to the serving mobile phone carrier in China. The calling party, therefore, can reach the subscriber when they are in the US or when they are in China by simply dialing the subscriber's US phone number.

However, there is a 12- to 14-hour time zone difference between China and the US, which can present inconveniences to subscribers as they travel. For people who frequently travel, the calling party is typically not aware of the present location of the subscriber or the time zone in which the subscriber is presently located. A calling party in the US may call the subscriber during normal US working hours, but this call is delivered to the subscriber in the middle of the night, local time, where the subscriber is located. To avoid this situation, the subscriber typically turns off their mobile phone, which makes them unavailable to all incoming calls, including emergency calls, in order to avoid being disturbed at inappropriate times. Thus, all incoming calls fail to reach the subscriber and typically are redirected to the subscriber's voicemail service, where they must be retrieved by the subscriber at a later time.

If the subscriber leaves their mobile phone turned on at all times, the time zone differences can result in the subscriber being awakened in the middle of the night by a routine call, or being disturbed during dinner, or being disturbed during important business meetings. If the mobile subscriber turns off their mobile phone, for example, during the night (local time), the calling party may question why the subscriber has their mobile phone turned off during normal working hours. In addition, there is presently no way for farily members or co-workers to reach the subscriber in the case of an emergency if the mobile subscriber turns off their mobile phone during night hours (local time).

### BRIEF SUMMARY OF THE INVENTION

The present time of day warning system provides the subscriber with the ability to designate at least one time interval during the course of the day when the subscriber prefers not to receive calls on their mobile phone unless these incoming calls are of an urgent nature. In this system, if the subscriber has enrolled in the Time Of Day Warning Service and their mobile phone is turned on, when someone attempts to call the subscriber, the mobile phone system determines the present time of day at the subscriber's present location. If the incoming call is attempted during one of the subscriber-designated blackout time intervals, the incoming call is intercepted. The calling party receives a recorded message which indicates the present time at the subscriber's present location and an indication that the subscriber is not taking calls at this time. The calling party then is provided with one or more call forwarding options, including leaving a voicemail message and the ability to complete the call connection to the subscriber's mobile phone. In this manner, the subscriber is not disturbed by unwanted calls at designated times, but can be reached if the call is of an urgent nature.

### BRIEF DESCRIPTION OF THE DRAWINGS

FIG. 1 illustrates, in block diagram form, the overall architecture of a mobile phone network that spans multiple time zones;

FIG. 2 illustrates, in flow diagram form, the operation of the present time of day warning system to enable a subscriber to enroll in the time of day warning service and set their time preferences; and

FIG. 3 illustrates, in flow diagram form, the operation of the present time of day warning system in response to receipt of an incoming call that is directed to the subscriber.

### DETAILED DESCRIPTION OF THE INVENTION

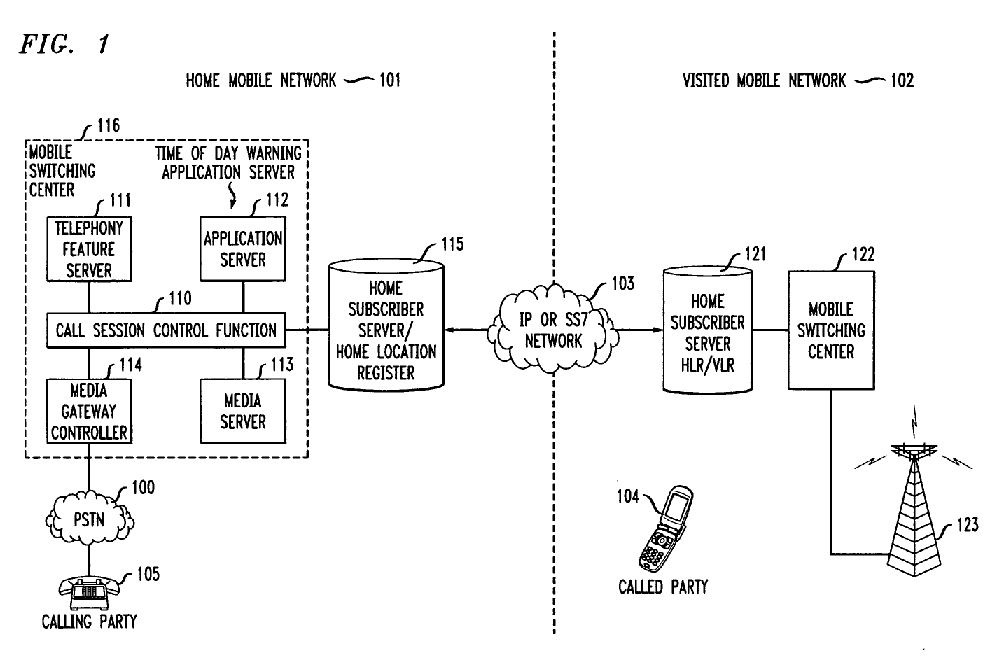

FIG. 1 illustrates, in block diagram form, the overall architecture of a mobile phone network that spans multiple time zones. The called party 104 has a mobile service subscription with Home Mobile Network 101, which is the mobile phone system that serves the subscriber's home location. FIG. 1 also illustrates the Public Switched Telephone Network 100 which serves wire-line telephones and mobile phones which are served by Mobile Networks (not shown) located remotely from the subscriber's Home Mobile Network 101. The Home Mobile Network 101 is connected to other mobile phone networks, such as Visited Mobile Network 102 via an IP or SS7 Network 103 for the exchange of control data in conjunction with the processing of communication connections for mobile phones which are located in the service area of the respective mobile networks, as is well known in the art.

The Visited Mobile Network 102 includes Mobile Switching Center 122 which operates cell site 123 to establish wireless communication connections with cell phones 104 that are operational in the coverage area of the cell site 123. The Visited Mobile Network 102 also includes a Home Subscriber Server 121 which is equipped with a Home Location Register (HLR) to serve mobile phones which have a subscription with Visited Mobile Network 102 as well as a Visited Location Register (VLR) to serve roaming mobile phones. A Home Subscriber Server 121 is part of a third generation IP multimedia subsystem (3G IMS). The IMS Home Subscriber Server 121 is the central subscriber database for next-generation IP and GSM networks. The Home Subscriber Server design usually follows a distributed database model serving both IMS applications (Call Session Control Function) and GSM applications (Home Location Register). Home Subscriber Servers are generally designed to support multiple subscriber types including VoIP, Wi-Fi, GSM/GPRS, and 3G mobile subscribers. Managing one profile per subscriber dramatically reduces network complexity and operational expenditures, allows a single source for a subscriber's provisioning, and enables new, intelligent call routing. The Home Subscriber Server provides mobile phone location, IP, authentication, service, and presence data.

The Home Mobile Network 101 includes various feature control systems, located in the Mobile Switching Center 116, that are used by the Home Mobile Network 101 to provide subscribers with various communication services, such as the Time Of Day Warning Service described herein. The Call Session Control Function 110 is connected to various feature subsystems, including the Telephony Feature Server 111 which provides basic telephone services, an Application Server 112 which provides the Time Of Day Warning Service, a Media Server 113 which provides various media-centric applications (such as recorded announcements), and Media Gateway 114 which interconnects the Call Session Control Function 110 of the Mobile Switching Center 116 to the Public Switched Telephone Network 100. The Call Session Control Function provides session control for subscribers accessing services within the IP Multimedia Core Network In essence, the Call Session Control Function is an SIP Server. It has responsibility for interacting with network databases such as the Home Subscriber Server for mobility and AAA (Access, Authorization, and Accounting) Servers for security. The Home Mobile Network 101 also includes a Home Subscriber Server 115 which is equipped with a Home Location Register (HLR) to serve mobile phones which, have a subscription with Home Mobile Network 101.

### Time of Day Warning Sign-Up Service

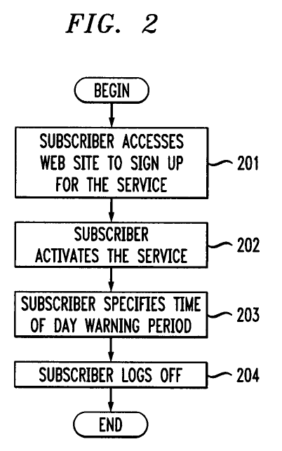

FIG. 2 illustrates, in flow diagram form, the operation of the present Time Of Day Warning System to enable a subscriber to enroll in the Time Of Day Warning Service and to set their time preferences. Obviously, there are many alternative processes that can be used to enable a subscriber to set their time preferences, and this description is intended to teach the functions described therein, not to limit the scope of this process.

At step 201, the subscriber uses their personal computer system (not shown) to access the Internet and log into a WEB site, operated by the common carrier that operates the subscriber's Home Mobile Network 101 and that provides the Time Of Day Warning Sign-Up Service. The WEB site provides the subscriber with a set of user interface screens which enables the subscriber to log into the Time Of Day Warning Sign-Up Service in conventional fashion. At step 202, the subscriber activates the Time Of Day Warning Service pursuant to the sign-up process established by the common carrier which operates the Home Mobile Network 101.

At step 203, the subscriber specifies at least one time interval during which they do not wish to receive incoming calls. This time interval is also termed a Time Of Day Warning Period to indicate that the subscriber can keep their mobile phone on during this time interval, and the mobile phone network screens the incoming calls by intercepting incoming calls directed to the subscriber during the Time Of Day Warning Period(s), and provides the calling party with a recorded message to alert the calling party of the unavailability of the subscriber. The subscriber can select one or more time intervals during which incoming calls are blocked. These times can be, for example, a sleep interval, a dinner interval, or even for the duration of important meetings. At step 204, the subscriber logs off the WEB site and the Time Of Day Warning System is activated.

### Operation of The Time of Day Warning System

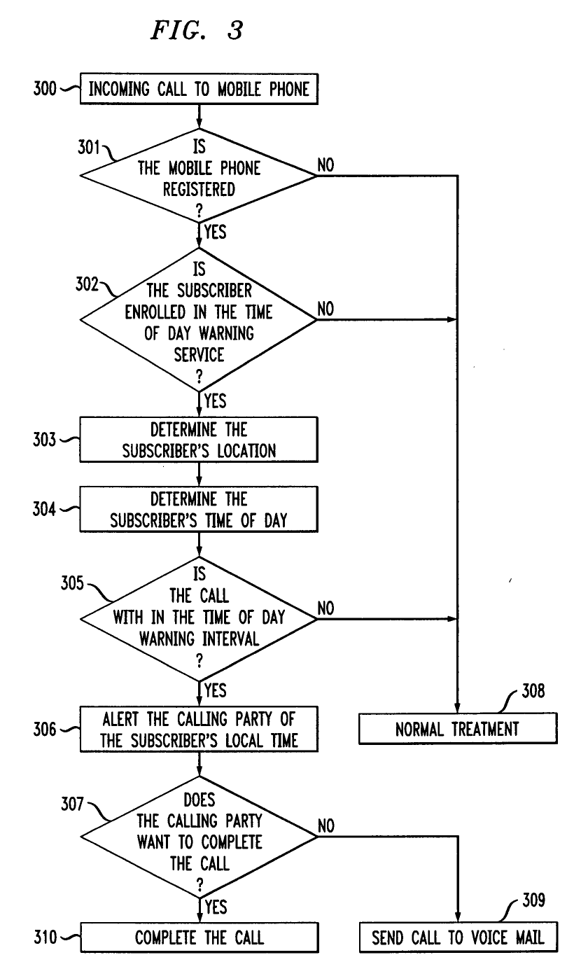

FIG. 3 illustrates, in flow diagram form, the operation of the present Time Of Day Warning System in response to receipt of an incoming call that is directed to the subscriber. As an illustration of the operation of the Time Of Day Warning System, the flow chart of FIG. 3 presents a typical scenario, but obviously there are alternative implementations of this process that are possible and which would fall within the scope of the appended claims.

As part of the standard operation of mobile phone networks, when the subscriber roams from their Home Mobile Network 101 to a Visited Mobile Network 102, the Visited Mobile Network 102 registers the roaming mobile phone 104 on the Visited Mobile Network 102 once the subscriber activates their mobile phone 104 and is in wireless communication with cell site 123 and the associated Mobile Switching Center 122. As part of this process, the Visited Location Register VLR in the Home Subscriber Server 121 of the Visited Mobile Network 102 notifies the Home Subscriber Server 115 in the Home Mobile Network 101 that the subscriber is registered on the Visited Mobile Network 102, and this data is stored in the Home Location Register (HLR) of the subscriber's Home Subscriber Server 115. In this example, the subscriber is also subscribed to the Time Of Day Warning Service, and the subscriber has specified the time interval(s) during which they do not want to be disturbed.

The calling party at phone 105 initiates a call at step 300 to the subscriber's mobile phone 104. The incoming call is extended over the Public Switched Telephone Network 100 to the Home Mobile Switching Center 116 and is terminated on an IMS Media Gateway 114. The calling party identification information is received by the Call Session Control Function 110, which processes the incoming call and forwards this information to the Telephony Feature Server 111 assigned to the called mobile phone 104. Based on the Initial Filter Criteria data that is stored in the Home Subscriber Server 115 for the called mobile phone 104, the Call Session Control Function 110 routes the call from the Telephony Feature Server 111 to the Application Server 112 which provides the Time Of Day Warning Feature logic. The Application Server 112, at step 301, queries the Home Subscriber Server 115 to determine if the subscriber is registered anywhere in the Mobile Network, since the Home Location Register (HLR) stores the present location and service status for the mobile phone 104. If the subscriber is not registered, this is an indication that the subscriber has turned off the mobile phone 104, or the mobile phone 104 is located in an area where mobile phone service is unavailable. In this case, the incoming call receives normal call completion service from the Application Server 112 at step 308 where the calling party is routed to the voicemail server for the called mobile phone 104.

If the subscriber's mobile phone 104 is registered on the mobile network, call processing advances to step 302 where the Application Server 112 determines whether the subscriber is enrolled in the Time Of Day Warning Service. If the subscriber is not enrolled in the Time Of Day Warning Service, the incoming call is routed to the Application Server 112 and receives normal call completion service at step 308, where the incoming call is completed to the called mobile phone 104.

If the subscriber's mobile phone 104 is registered on the mobile network and the subscriber is enrolled in the Time Of Day Warning Service, call processing advances to step 303 where the Application Server 112 determines the present location of the subscriber's mobile phone 104 to determine whether the subscriber is registered in the Home Mobile Network 101 or Visited Mobile Network 102. The Time Of Day Warning Service, in this example, is not provided (as an administrative decision) to the subscriber if their mobile phone is operational in their Home Mobile Network 101. If the subscriber's mobile phone 104 is presently registered in their Home Mobile Network 101, the incoming call is routed to the Application Server 112 and receives normal call completion service at step 308, where the incoming call is completed to the called mobile phone 104.

If the Application Server 112 determines at step 303 that the subscriber has roamed to a Visited Mobile Network 102, at step 304, the Application Server 112 calculates the present time at the Visited Mobile Network 102. This is done by combining the present time in the Home Mobile Network 101 with the time difference (positive or negative) between the Home Mobile Network 101 and Visited Mobile Network 102. The present location of the subscriber and the time zone at that location can be determined by the Visited Location Register (VLR). As the mobile phone 104 travels to other mobile networks, the Home Location Register (HLR) receives update messages from the Visited Mobile Network 102 that indicate the Visited Location Register (VLR) that is presently serving the subscriber's mobile phone 104. The Home Location Register (HLR) can maintain a table that indicates the time zone difference between the Home Location Register (HLR) and each Visited Location Register (VLR). This process is consistent with the present exchange of messages between the Visited Location Register (VLR) and the Home Location Register (HLR) to update the present location information for the subscriber. If the Home Location Register (HLR) fails to maintain a table of Visited Location Register (VLR) time zones, the Home Location Register (HLR) can query each Visited Location Register (VLR) to which the subscriber roams. A third approach is for the Visited Mobile Network 102 to support mobile phone location queries, where the Home Location Register (HLR) queries the Visited Mobile Network 102 for the present physical location of the mobile phone 104 in terms of latitude and longitude (from the GPS in the mobile phone 104 or signal strength triangulation from several cell towers). The Home Location Register (HLR) uses the physical location information to determine the present time zone and the time of day for the subscriber's mobile phone 104. Another approach is to directly query the subscriber's mobile phone 104, since many mobile phones update the time of day display based on the data provided by the serving mobile phone network.

The Application Server 112 then compares the present time in the Visited Mobile Network 102 with the time interval which the subscriber has specified for accepting calls at step 305. If the present time of day of the call does not fall within the designated Time Of Day Warning Interval, the incoming call is routed to the Application Server 112 and receives normal call completion service at step 308, where the incoming call is completed to the called mobile phone 104.

If the present time of day of the call falls within the designated Time Of Day Warning Interval, the incoming call is routed at step 306 to a Media Server 113 with instructions to play the warning message. The calling party at phone 105 receives an announcement that typically notes:
The party you are attempting to reach has roamed to a time zone in which the local time is XXX. If you want to leave a voice message, press 1. If this call is an emergency and you want to complete the call, press 2.

If the calling party signals the Media Server 113 that they want to leave a message, the call is forwarded to a voicemail server (not shown) or an operator/call coverage service for the called party at step 309.

If the calling party at phone 105 signals that they wish to proceed with the call, the Application Server 112 signals the Telephony Feature Server 111 to complete the call at step 310. In order to prevent the subscriber from receiving an unwanted call from a calling party who disregards the intent of the recorded announcement—blocking all but emergency calls—the Time Of Day Warning System optionally can include a feature where the calling party must input a pass code to have the incoming call completed to the called party, or the Application Server 112 can use the calling party identification to match to a list of parties permitted to complete calls to the subscriber during the Time Of Day Warning Interval.

### SUMMARY

The present time of day warning system provides the subscriber with the ability to designate times of day when the subscriber prefers to receive calls on their mobile phone only if these incoming calls are of an urgent nature. When someone attempts to call the subscriber, the mobile phone system determines the present time of day at the subscriber's present location. If the incoming call is attempted during one of these subscriber-designated times, the incoming call is intercepted.

What is claimed as new and desired to be protected by Letters Patent of the United States is:

1. A time of day warning system, operational in a mobile phone network, for redirecting incoming calls, initiated to a mobile subscriber's mobile phone at mobile subscriber designated times of day when the subscriber elects not to receive calls on their mobile phone, comprising:
time interval indication means for storing data received from a subscriber indicative of at least one time interval during which the mobile subscriber does not wish to receive incoming calls;
present time determining means, responsive to receipt of an incoming call directed to said mobile subscriber, for determining a present time at the mobile subscriber's present location; and
incoming call redirection means, responsive to said present time at the mobile subscriber's present location corresponding to one of said at least one time interval, for redirecting said incoming call to an alternate destination.

2. The time of day warning system of claim 1 wherein said alternate destination comprises one of the class of alternate destinations including: a recorded announcement system, an operator, call coverage service, and a voicemail system.

3. The time of day warning system of claim 1 wherein said present time determining means comprises:
Visited Location Register query means for transmitting a query to a Visited Location Register presently serving said mobile phone to determine a present time at said mobile subscriber's present location.

4. The time of day warning system of claim 1 wherein said present time determining means comprises:
Visited Location Register query means for transmitting a query to a Visited Location Register presently serving said mobile phone to determine a present location of said mobile subscriber's mobile phone; and
present time computation means for combining a present time at said mobile subscriber's home location with a time difference, indicative of the time difference between said mobile subscriber's present location and the subscriber's home location, to determine a present time at said mobile subscriber's present location.

5. The time of day warning system of claim 1 wherein said present time determining means comprises:
location determining means for determining a present physical location of said mobile subscriber's mobile phone;
time zone determining means, responsive to said determined present physical location of said subscriber's mobile phone, for identifying a time zone in which said subscriber's mobile phone is operational; and
present time computation means for combining a present time at said mobile subscriber's home location with a time zone difference, indicative of the time difference between said identified time zone and the subscriber's home location, to determine a present time at said mobile subscriber's present location.

6. The time of day warning system of claim 1 further comprising:
subscriber mobile phone registration means for determining if said subscriber's mobile phone is registered on a mobile network;
subscription means for determining whether said subscriber is enrolled in a time of day warning service; and
wherein said incoming call redirection means is further responsive to said subscriber's mobile phone being registered on a mobile network, said subscriber being enrolled in a time of day warning service, and said present time at the mobile subscriber's present location corresponding to one of said at least one time interval, for redirecting said incoming call to an alternate destination.

7. The time of day warning system of claim 1 further comprising:
roaming determination means, responsive to said subscriber's mobile phone failing to be in a roaming mode, for disabling said incoming call redirection means, to enable incoming calls to be completed to said subscriber's mobile phone when said present time at the mobile subscriber's present location corresponds to one of said at least one time interval.

8. A method of operating a time of day warning system, operational in a mobile phone network for redirecting incoming calls, initiated to a mobile subscriber's mobile phone at mobile subscriber designated times of day when the subscriber elects not to receive calls on their mobile phone, comprising:
storing data received from a subscriber indicative of at least one time interval during which the mobile subscriber does not wish to receive incoming calls;
determining, in response to receipt of an incoming call directed to said mobile subscriber, a present time at the mobile subscriber's present location; and
redirecting, in response to said present time at the mobile subscriber's present location corresponding to one of said at least one time interval, said incoming call to an alternate destination.

9. The method of operating a time of day warning system of claim 8 wherein said alternate destination comprises one of the class of alternate destinations including: a recorded announcement system, an operator, call coverage service, and a voicemail system.

10. The method of operating a time of day warning system of claim 8 wherein said step of determining comprises:
transmitting a query to a Visited Location Register presently serving said mobile phone to determine a present time at said mobile subscriber' present location.

11. The method of operating a time of day warning system of claim 8 wherein said step of determining comprises:
transmitting a query to a Visited Location Register presently serving said mobile phone to determine a present location of said mobile subscriber' mobile phone; and
combining a present time at said mobile subscriber' home location with a time difference, indicative of the time difference between said mobile subscriber's present location and the subscriber's home location, to determine a present time at said mobile subscriber's present location.

12. The method of operating a time of day warning system of claim 8 wherein said step of determining comprises:
determining a present physical location of said mobile subscriber's mobile phone;
identifying, in response to said determined present physical location of said subscriber's mobile phone, a time zone in which said subscriber's mobile phone is operational; and
combining a present time at said mobile subscriber's home location with a time zone difference, indicative of the time difference between said identified time zone and the subscriber's home location, to determine a present time at said mobile subscriber's present location.

13. The method of operating a time of day warning system of claim 8 further comprising:
determining if said subscriber's mobile phone is registered on a mobile network;
determining whether said subscriber is enrolled in a time of day warning service; and
wherein said step of redirecting is further responsive to said subscriber's mobile phone being registered on a mobile network said subscriber being enrolled in a time of day warning service, and said present time at the mobile subscriber's present location corresponding to one of said at least one time interval for redirecting said incoming call to an alternate destination.

14. The method of operating a time of day warning system of claim 8 further comprising:
disabling, in response to said subscriber's mobile phone failing to be in a roaming mode, said step of redirecting, to enable incoming calls to be completed to said subscriber's mobile phone when said present time at the mobile subscriber's present location corresponds to one of said at least one time interval.
